(19) United States
(12) Patent Application Publication
(10) Pub. No.: US 2020/0134558 A1
(43) Pub. Date: Apr. 30, 2020

(54) ORDER ALLOCATION METHOD AND DEVICE

(71) Applicant: BEIJING XIAODU INFORMATION TECHNOLOGY CO., LTD., Beijing (CN)

(72) Inventors: Jinqing CHEN, BEIJING (CN); Mingquan XU, BEIJING (CN); Shaojian HUANG, BEIJING (CN); Ke XIAN, BEIJING (CN); Qiuyuan YANG, BEIJING (CN); Dairui CUI, BEIJING (CN); Jiajia RAO, BEIJING (CN)

(21) Appl. No.: 16/728,558

(22) Filed: Dec. 27, 2019

Related U.S. Application Data
(63) Continuation of application No. PCT/CN2017/110297, filed on Nov. 9, 2017.

(30) Foreign Application Priority Data
Jun. 27, 2017 (CN) 201710500827.2

(51) Int. Cl. G06Q 10/08; G06Q 30/06; G06Q 10/06

(52) U.S. Cl. CPC G06Q 10/0834; G06Q 10/087; G06Q 10/06311; G06Q 30/0635

(57) ABSTRACT

An order allocation method and apparatus are provided. The order allocation method includes: obtaining an unallocated order corresponding to a first delivery business; determining a first matching degree between the unallocated order and each of allocated order groups of a plurality of candidate delivery persons, wherein the allocated order groups include an order group corresponding to a second delivery business; and if there is an allocated order group that meets a matching degree requirement, assigning the unallocated order to that allocated order group. Each of the allocated order groups may include allocated orders corresponding to the first delivery business and the second delivery business. Therefore, joint allocation and scheduling of orders of the two delivery businesses in a same order group can be implemented based on the matching degree, so that different delivery businesses can share a same batch of delivery persons, thereby improving utilization of the delivery capacity.

### CROSS-REFERENCE TO RELATED APPLICATION

This application is a continuation application of International Patent Application No. PCT/CN2017/110297, filed on Nov. 9, 2017, which is based on and claims priority to the Chinese Patent Application No. 201710500827.2, filed on Jun. 27, 2017 and entitled “ORDER ALLOCATION METHOD AND DEVICE.” The above-referenced applications are incorporated herein by reference in their entirety.

### TECHNICAL FIELD

This disclosure relates to the field of Internet technologies, and in particular, to an order allocation method and apparatus.

### BACKGROUND

With the development of Internet technologies, Online-To-Offline (020) service, as a new service model, has greatly changed people's life. For example, in terms shopping, with an online shopping application, users can purchase their desired goods online without leaving their home, and the orders may be delivered through offline delivery.

In practice, there are two types of common delivery businesses: a collect-on-delivery business and a takeout delivery business. Currently, different delivery businesses are independent of each other, and different delivery persons and order scheduling mechanisms are used.

### SUMMARY

Currently, delivery persons separately perform order delivery for different delivery businesses, so that respective delivery requirements can be met. However, delivery persons are usually arranged based on the greatest delivery pressure to ensure service quality of various delivery businesses. In some cases, that may lead to redundant delivery persons, and a waste of delivery resources.

A collect-on-delivery business and a takeout delivery business may have different delivery peak hours each day. More specifically, for a takeout order, delivery peak hours are mainly during dining peak hours at the noon and in the evening. Therefore, delivery capacity may be in high demand at the peak hours at the noon and in the evening, and may be in an idle state in a time other than the peak hours. For a collect-on-delivery order, delivery peak hours are mainly in the morning, and the delivery capacity is usually in an idle state in other times.

Therefore, if the collect-on-delivery order and the takeout order can share a same batch of delivery persons, in other words, if joint allocation and scheduling of the collect-on-delivery order and the takeout order can be implemented, utilization of the delivery capacity can be greatly improved, and delivery costs can be reduced.

In view of this, this disclosure provides an order allocation method and apparatus, so that orders of different delivery businesses can share a same batch of delivery persons, to improve utilization of the delivery capacity, and reduce delivery costs.

A first aspect of this disclosure is directed to an order allocation method. The method may include: obtaining an unallocated order that corresponds to a first delivery business; determining a first matching degree between the unallocated order and each of allocated order groups of a plurality of candidate delivery persons. The allocated order groups may include an order group corresponding to a second delivery business.

The method may further include: if one allocated order group of the allocated order groups of the plurality of candidate delivery persons meets a matching degree requirement, designating the allocated order group that meets the matching degree requirement to be a target order group; and assigning the unallocated order to the target order group.

A second aspect of this disclosure is directed to an order allocation apparatus. The apparatus may include an obtaining module, a first determining module, and a first allocation module.

The obtaining module may be configured to obtain an unallocated order. The unallocated order may correspond to a first delivery business. The first determining module may be configured to determine a first matching degree between the unallocated order and each of allocated order groups of a plurality of candidate delivery persons. The allocated order groups may include an order group corresponding to a second delivery business. The first allocation module may be configured to: if one allocated order group of the allocated order groups of the plurality of candidate delivery persons meets a matching degree requirement, designate the allocated order group that meets the matching degree requirement as a target order group; and assign the unallocated order to the target order group.

In a possible design, the order allocation apparatus may include a processor and a memory. The memory may be configured to store a program that supports the order allocation apparatus in performing the order allocation method in the first aspect, and the processor may be configured to execute the program stored in the memory. The order allocation apparatus may further include a communications interface, configured to be used by the order allocation apparatus to communicate with another device or a communications network.

A third aspect of this disclosure is directed to a computer storage medium. The computer storage medium may be configured to store a computer software instruction used by an order allocation apparatus, and the computer software instruction may include a related program used to perform the order allocation method in the first aspect.

According to the order allocation method and apparatus provided in this disclosure, when assigning an unallocated order corresponding to the first delivery business, a first matching degree between the unallocated order and each allocated order group of each candidate delivery person may be determined. If one allocated order group of a plurality of allocated order groups meets a matching degree requirement, the allocated order group that meets the matching degree requirement may be designated as a target order group, and the unallocated order may be assigned to the target order group to complete the allocation of the unallocated order. Each allocated order group may include at least one allocated order of the second delivery business. That is, each allocated order group may include not only an allocated order corresponding to the first delivery business, but also an allocated order corresponding to the second delivery business. Therefore, joint allocation and scheduling of the order of the first delivery business and an order of the second delivery business in a same order group can be implemented based on the first matching degree between the unallocated order and each allocated order group, so that different delivery businesses can share a same batch of delivery persons, thereby reducing delivery costs, and improving utilization of the delivery capacity.

### BRIEF DESCRIPTION OF THE DRAWINGS

To describe the technical solutions in the embodiments of this disclosure or related technologies more clearly, the following briefly describes the accompanying drawings required for describing the embodiments or the related technologies. Apparently, the accompanying drawings in the following description show some embodiments of this disclosure, and a person of ordinary skill in the art may still derive other drawings from these accompanying drawings without creative efforts.

FIG. 1 is a flowchart of a first embodiment of an order allocation method of this disclosure.

FIG. 2 is a flowchart of a second embodiment of an order allocation method of this disclosure.

FIG. 3 is a flowchart of a third embodiment of an order allocation method of this disclosure.

FIG. 4 is a schematic structural diagram of a first embodiment of an order allocation apparatus of this disclosure.

FIG. 5 is a schematic structural diagram of a second embodiment of an order allocation apparatus of this disclosure.

FIG. 6 is a schematic structural diagram of a third embodiment of an order allocation apparatus of this disclosure.

FIG. 7 is a schematic structural diagram of an electronic device corresponding to an order allocation apparatus according to an embodiment of this disclosure.

### DETAIL DESCRIPTION OF THE EMBODIMENTS

To make the objectives, technical solutions, and advantages of the embodiments of this disclosure clearer, the following clearly and completely describes the technical solutions in the embodiments of this disclosure with reference to the accompanying drawings. Apparently, the described embodiments are some rather than all of the embodiments of this disclosure. All other embodiments obtained by a person of ordinary skill in the art based on the embodiments of this disclosure without creative efforts shall fall within the protection scope of this disclosure.

The terms used in the embodiments of this disclosure are merely for the purpose of illustrating specific embodiments, and are not intended to limit this disclosure. The terms “a” and “the” of singular forms used in the embodiments and the appended claims of this disclosure are also intended to include plural forms, unless otherwise specified in the context clearly. The term “a plurality of” usually includes at least two, but a case of at least one is not excluded.

The term “and/or” used in this specification describes only an association relationship for describing associated objects and represents that three relationships may exist. For example, A and/or B may represent the following three cases: only A exists, both A and B exist, and only B exists. In additional, the character “/” in this specification usually indicates an “or” relationship between associated objects.

Although terms such as “first”, “second”, and “third” may be used to describe specific items in the embodiments of this disclosure, the specific items should not be limited to these terms. These terms are merely used to distinguish between the specific items. For example, without departing from the scope of the embodiments of this disclosure, a first “object” may also be referred to as a second “object”, and similarly, the second “object” may also be referred to as the first “object”.

Depending on the context, for example, the word “if” used herein may be explained as “while”, “when”, “in response to determining”, or “in response to detecting”. Similarly, depending on the context, the phrase “if determining” or “if detecting (a stated condition or event)” may be explained as “when determining”, “in response to determining”, “when detecting (the stated condition or event)”, or “in response to detecting (the stated condition or event)”.

It should be further noted that the term “include”, “comprise”, or any other variant thereof is intended to cover a non-exclusive inclusion, so that a product or a system that includes a list of elements not only includes those elements but also includes other elements that are not expressly listed, or further includes elements inherent to such product or system. An element defined by “includes a . . . ” may further include, without more constraints, another identical element in the product or system that includes the element.

It should be further noted that a sequence of steps in the embodiments of the disclosure is adjustable, and the steps are not necessarily performed in the sequence specified in the embodiments.

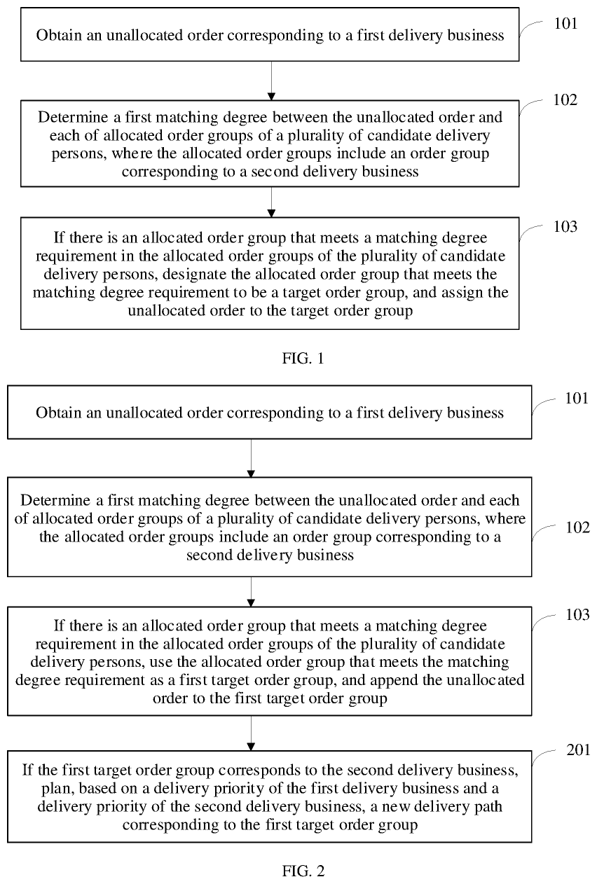

FIG. 1 is a flowchart of a first embodiment of an order allocation method of this disclosure. The order allocation method provided in this embodiment may be performed by an order allocation apparatus. The order allocation apparatus may be implemented as software or a combination of software and hardware. The order allocation apparatus may be integrated into a device, such as a server, on a logistics scheduling platform. As shown in FIG. 1, the method may include the following steps.

In step 101, an unallocated order corresponding to a first delivery business may be obtained.

In step 102, a first matching degree between the unallocated order and each of allocated order groups of a plurality of candidate delivery persons may be determined. The allocated order groups may include an order group corresponding to a second delivery business.

In step 103, if there is an allocated order group that meets a matching degree requirement in the allocated order groups of the plurality of candidate delivery persons, the allocated order group that meets the matching degree requirement may be designated as a target order group, and the unallocated order may be assigned to the target order group.

A basic principle of the order allocation method provided in this embodiment is to implement joint scheduling of orders of different types of delivery businesses. Optionally, the joint scheduling may be implemented as follows. An unallocated order of a delivery business may be assigned to an allocated order group corresponding to another delivery business, so that an allocated order group of a delivery person may include orders from different delivery businesses, thereby implementing joint scheduling of orders of different types of delivery businesses. “Assigned to” may be alternatively understood as “combined with”.

To implement joint scheduling of orders of different delivery businesses, the server may receive orders from different delivery businesses. A collect-on-delivery business and a takeout delivery business are used as examples, and in this case, the server may receive not only a takeout order, but also a collect-on-delivery order.

In this embodiment of this disclosure, two common delivery businesses, namely, the collect-on-delivery business and the takeout delivery business, are used as examples. However, this disclosure is not limited to joint scheduling of the two example delivery businesses.

Optionally, to improve scheduling efficiency, the server may preset a scheduling period, and perform joint scheduling for N unallocated orders received in one scheduling period. Alternatively, if a quantity of unallocated orders received in one scheduling period is less than a preset quantity threshold, the server may perform joint scheduling for N unallocated orders received in two or more scheduling periods, where N is greater than 1. Specifically, each unallocated order may be associated with a delivery business identifier to identify a delivery business corresponding to each order.

In addition, there may be an optional order scheduling mechanism based on a delivery area. The scheduling mechanism may include two aspects. First, a delivery area to which an unallocated order belongs to may be determined. Second, a delivery person belongs to the delivery area may be determined. Therefore, the scheduling mechanism may be understood as allocating an unallocated order that belongs to a delivery area to a delivery person that belongs to the delivery area for delivery. Based on this, the N unallocated orders currently obtained by the server may be N unallocated orders corresponding to a same delivery area. The delivery area may be obtained by dividing a city in advance, and a plurality of delivery areas may be obtained.

N unallocated orders that belong to a delivery area may be obtained by the server. More specifically, the server may determine, based on an address attribute of each unallocated order obtained in at least one scheduling period, a delivery area corresponding to each unallocated order, so as to collect unallocated orders corresponding to a same delivery area to obtain N unallocated orders corresponding to each delivery area.

Regardless of a delivery business corresponding to an unallocated order, the unallocated order usually has a delivery address and/or a receiver address, and a delivery area to which the unallocated order belongs may be determined based on a delivery area with a coverage area in which the delivery address and/or the receiver address of the unallocated order located.

Specifically, a collect-on-delivery order corresponding to the collect-on-delivery business may have a delivery address and a receiver address. The delivery address may be a distribution center address, and the receiver address may be an address of a receiver. Optionally, a delivery area to which the collect-on-delivery order belongs may be determined based on a delivery area to which the distribution center address belongs. Similarly, a takeout order corresponding to the takeout delivery business may also have a delivery address and a receiver address. The delivery address may be an address of a merchant, and the receiver address may be an address of a receiver. Optionally, a delivery area to which the takeout order belongs may be determined based on a delivery area to which the address of the merchant belongs.

In summary, the server may obtain a plurality of unallocated orders that correspond to different delivery businesses and that belong to a same delivery area, to perform joint scheduling for the N unallocated orders. Accordingly, the unallocated order obtained in step 101 may be any one of the N unallocated orders currently received by the server.

In this embodiment, it is assumed that the first delivery business is the takeout delivery business and the second delivery business is the collect-on-delivery business. In this case, the unallocated order may be an unallocated takeout order. It may be understood that, in some embodiments, the first delivery business may be the collect-on-delivery business and the second delivery business may be the takeout delivery business, the order allocation method of this disclosure is also applicable to these embodiments.

The first matching degree between the currently obtained unallocated takeout order and each of the allocated order groups of the candidate delivery persons may be calculated. Based on the first matching degree, whether there is an allocated order group that meets the preset matching degree requirement may be determined. Then, the unallocated takeout order that meets the matching degree requirement may be assigned to the allocated order group. The allocated order groups may include the order group corresponding to the second delivery business.

The plurality of candidate delivery persons may be delivery persons that belong to a delivery area corresponding to an unallocated takeout order. A delivery area to which a delivery person belongs may be determined based on a delivery area selected when the delivery person registers with the server. Each candidate delivery person may have received some orders, and the orders each candidate delivery person received may exist in a form of an order group, which is referred to as an allocated order group.

In this embodiment, a delivery business type corresponding to any allocated order group of any candidate delivery person may be determined based on delivery business types corresponding to the majority of orders in the allocated order group. For example, if an allocated order group includes a total of 10 orders, eight orders are takeout orders, and two orders are collect-on-delivery orders, the allocated order group is a takeout order group.

For an allocated order group of any candidate delivery person, optionally, when the first matching degree between the unallocated takeout order and the allocated order group is calculated, a measurement parameter of the first matching degree may include an order similarity, or may include an order similarity and an order aggregation feature.

An order similarity between the unallocated takeout order and an allocated order group may be an average value of similarities between the unallocated takeout order and all allocated orders in the allocated order group. Optionally, a similarity measurement parameter corresponding to the order similarity may include at least one of the following parameters: a distance between delivery addresses, a distance between receiver addresses, and a time difference between expected delivery times.

Therefore, when the measurement parameter of the first matching degree is the order similarity, if the order similarity between the unallocated takeout order and an allocated order group is greater than a preset threshold, it may be determined that the allocated order group meets the matching degree requirement, the allocated order group may be designated as the target order group, and the unallocated takeout order may be assigned to the target order group and be delivered by a corresponding delivery person. The allocated order groups may include not only an allocated takeout order group, but also an allocated collect-on-delivery order group. Therefore, the target order group may be an allocated takeout order group, or may be an allocated collect-on-delivery order group.

The order aggregation feature between the unallocated takeout order and an allocated order group may include a total quantity of orders including the unallocated takeout order and all the allocated orders in the allocated order group, a total transaction amount of these orders. Therefore, when the measurement parameter of the first matching degree is the order aggregation feature, if the total quantity of orders is less than a preset value, the total transaction amount of the orders is less than a preset amount, and the order similarity between the unallocated takeout order and the allocated order group is greater than a preset threshold, it may be determined that the allocated order group meets the matching degree requirement, the allocated order group may be designated as the target order group, and the unallocated takeout order may be assigned to the target order group and delivered by a corresponding delivery person.

Since there may be a plurality of candidate delivery persons, and each candidate delivery person may have a plurality of allocated order groups, there may exist many allocated order groups. In a process of calculating the first matching degree between the unallocated takeout order and each of the allocated order groups, there may be a plurality of allocated order groups that meet the matching degree requirement. In this case, optionally, an optimal allocated order group may be selected from the plurality of allocated order groups as the target order group based on a correspondence between delivery capacity pressure in a delivery area to which the unallocated takeout order belongs and a delivery business and/or a comparison result of the first matching degree corresponding to each of the plurality of allocated order groups, and the unallocated takeout order may be assigned to the target order group.

The correspondence between the delivery capacity pressure and the delivery business may be as follows. If there is high delivery capacity pressure in the delivery area, an allocated order group corresponding to the collect-on-delivery business (i.e., an allocated collect-on-delivery order group) may be preferentially selected. Otherwise, an allocated order group corresponding to the takeout delivery business (i.e., an allocated takeout order group) may be preferentially selected. This is because in actual application, a collect-on-delivery order is less sensitive to time than a takeout order. If there is relatively high delivery capacity pressure, it usually indicates that excessive takeout orders need to be delivered in the delivery area. In this case, the unallocated takeout order is preferentially assigned to the allocated collect-on-delivery order group. The unallocated takeout order is usually processed in a more timely manner in comparison with a case in which the unallocated takeout order is assigned to the allocated takeout order group.

Therefore, optionally, when the plurality of allocated order groups include not only the allocated takeout order group, but also the allocated collect-on-delivery order group, if the delivery capacity pressure is greater than a preset threshold, the allocated collect-on-delivery order group may be selected from the plurality of allocated order groups. If a quantity of selected allocated collect-on-delivery order groups is greater than 1, an allocated collect-on-delivery order group with a highest similarity may be further selected as the target order group based on a value of an order similarity between each selected allocated collect-on-delivery order group and the unallocated takeout order.

Based on the foregoing process, an unallocated takeout order can be assigned to an allocated order group of a delivery person, and the allocated order group may be a collect-on-delivery order group. Therefore, joint scheduling of orders of different delivery businesses is implemented, so that orders of different delivery businesses can share a same delivery person (i.e., a same delivery capacity), thereby improving utilization of the delivery capacity.

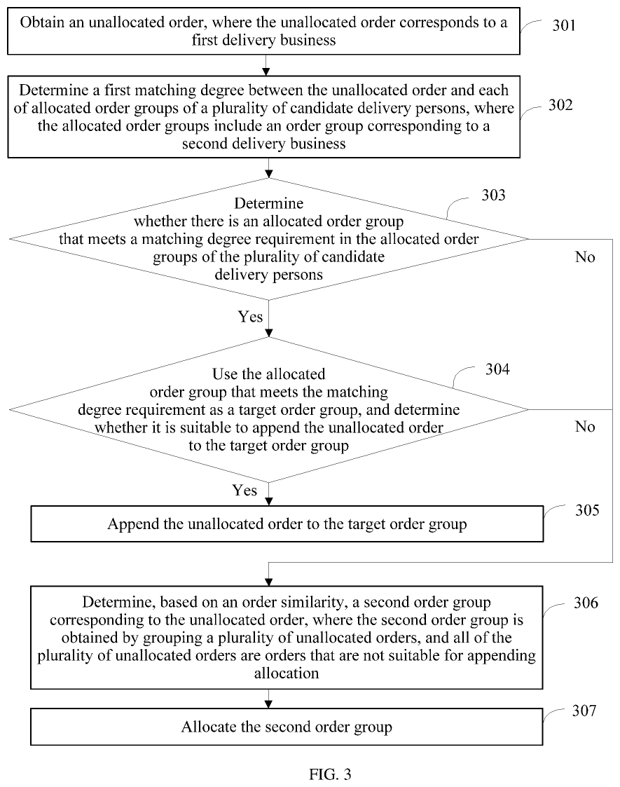

FIG. 2 is a flowchart of a second embodiment of an order allocation method of this disclosure. As shown in FIG. 2, based on the embodiment shown in FIG. 1, after step 103, the order allocation method may further include the following steps.

In step 201, if the target order group corresponds to the second delivery business, plan, based on a delivery priority of the first delivery business and a delivery priority of the second delivery business, a new delivery path corresponding to the target order group.

To help a delivery person to deliver an order more efficiently, a delivery path may be planned for each allocated order group of the delivery person, so that the delivery person can deliver the order more efficiently based on the delivery path.

In the foregoing embodiment, it is assumed that the unallocated order is an order corresponding to a takeout delivery business (i.e., an unallocated takeout order), and the second delivery business is a collect-on-delivery business. In this case, when the unallocated takeout order is assigned to the target order group, planning of the new delivery path corresponding to the target order group may be triggered regardless of whether the target order group is an allocated takeout order group or an allocated collect-on-delivery order group.

When the target order group is an allocated collect-on-delivery order group corresponding to the collect-on-delivery business, a priority of the collect-on-delivery business and a priority of the takeout delivery business need to be considered during the planning of a delivery path for the target order group. The collect-on-delivery business and the takeout delivery business may have different sensitivity to time, and the collect-on-delivery business may be far less sensitive to time than the takeout delivery business. Therefore, to ensure delivery timeliness of a takeout order, the priority of the collect-on-delivery business may be set to be lower than that of the takeout delivery business. Therefore, when the target order group includes not only a collect-on-delivery order, but also a takeout order, the takeout order may be delivered before the collect-on-delivery order in the delivery path. For a detailed process of delivery path planning, an existing related technology may be referred to. Details are not described herein again.

FIG. 3 is a flowchart of a third embodiment of an order allocation method of this disclosure. As shown in FIG. 3, the order allocation method may include the following steps.

In step 301, an unallocated order may be obtained. The unallocated order may correspond to a first delivery business.

In step 302, a first matching degree between the unallocated order and each of allocated order groups of a plurality of candidate delivery persons may be determined. The allocated order groups may include an order group corresponding to a second delivery business.

In step 303, whether there is an allocated order group that meets a matching degree requirement in the allocated order groups of the plurality of candidate delivery persons may be determined. If there is an allocated order group that meets the matching degree requirement, step 304 is performed. Otherwise, steps 306 and 307 are performed.

In step 304, the allocated order group that meets the matching degree requirement may be designated as a target order group, and whether it is suitable to assign the unallocated order to the target order group may be determined. If it is suitable to assign the unallocated order to the target order group, step 305 is performed. If it is not suitable to assign the unallocated order to the target order group, steps 306 and 307 are performed.

In step 305, the unallocated order is assigned to the target order group.

In step 306, based on an order similarity, a second order group corresponding to the unallocated order may be determined. The second order group may be obtained by grouping a plurality of unallocated orders, and all of the plurality of unallocated orders may be orders that are not suitable to be assigned.

In step 307, the second order group is allocated.

In the foregoing embodiment, it is assumed that the first delivery business is a takeout delivery business and the second delivery business is a collect-on-delivery business. In this case, the following unallocated order is an unallocated takeout order.

Based on the description in the foregoing embodiment, after the first matching degree between the unallocated order and each of the allocated order groups is obtained through calculation, if it is determined that there is no allocated order group that meets the matching degree requirement, it indicates that it is not suitable to assign the unallocated order to an allocated order group, and the unallocated order needs to be allocated in a grouping allocation manner. In addition, optionally, even if there is the target order group that meets the matching degree requirement, whether it is suitable to assign the unallocated order to the target order group may be further determined. If a determining result is that it is not suitable to assign the unallocated order to the target order group, it also indicates that it is not suitable to assign the unallocated order to the first target order group, and in this case, the unallocated order still needs to be allocated in the grouping allocation manner.

When the unallocated order needs to be allocated in the grouping allocation manner, an order group, which is referred to as the second order group, corresponding to the unallocated order needs to be first determined based on the order similarity. Then, an appropriate candidate delivery person needs to be selected to deliver the second order group.

The appropriate candidate delivery person may be selected in the following process.

A second matching degree between the second order group and each of the plurality of candidate delivery persons may be determined. A candidate delivery person that matches the second order group may be selected from the plurality of candidate delivery persons based on the second matching degree. The second order group may be allocated to the selected candidate delivery person.

A measurement parameter of the second matching degree may include a delivery indicator, an aggregation feature, and the like. For example, the aggregation feature may include a total quantity of orders of a candidate delivery person and a total transaction amount of orders, where it is assumed that a collect-on-delivery order group is allocated to the candidate delivery person. For an estimation process of the delivery indicator, the description in the foregoing embodiment may be referred to. The estimation process is similar to the description in the foregoing embodiment, and therefore is not described herein.

When there are a plurality of candidate delivery persons that meet the matching degree requirement, a most appropriate candidate delivery person may be selected based on degrees to which the plurality of candidate delivery persons meet the matching degree requirement, and the second order group is allocated to the selected candidate delivery person.

It should be noted that in this case, the object of the grouping allocation is an order that is in N unallocated orders received by a server and that is not suitable to be assigned.

For example, if the server receives 50 unallocated orders, and after the first matching degree is calculated for each of the 50 unallocated orders, the first matching degree between each of 20 orders and the allocated order group of each candidate delivery person does not meet the matching degree requirement, it is determined that the 20 orders are not suitable to be assigned. In addition, it is assumed that each of the remaining 30 orders corresponds to an allocated order group whose first matching degree with each of the remaining 30 orders meets the matching degree requirement. However, after determining whether the 30 orders are suitable to be assigned, if it is determined that six orders of these 30 orders not suitable to be assigned, then it is determined that none of the 20 orders and the six orders is suitable to be assigned. In this case, the 26 orders that are not suitable to be assigned are grouped. For an order grouping process, the implementation of an existing order grouping process may be referred to. Details are not described herein again.

As described above, whether it is suitable to assign the unallocated order to the target order group may be determined. Optionally, the determining process may be implemented as follows. A first delivery indicator and a second delivery indicator that correspond to the unallocated order may first be estimated. The first delivery indicator may correspond to that the unallocated order being pre-assigned to the target order group, the second delivery indicator may correspond to that the unallocated order being pre-allocated to another candidate delivery person different from a candidate delivery person corresponding to the target order group. Then, if the first delivery indicator is superior to the second delivery indicator, it is determined that it is suitable to assign the unallocated order to the target order group. If the first delivery indicator is not superior to the second delivery indicator, the unallocated order is not suitable to be assigned.

For example, the foregoing determining process may be briefly described as follows. If the unallocated order is an order X, and the order X is assigned to a target order group of a delivery person A, a first delivery indicator corresponding to the order X in this case is estimated. In addition, if the order X is allocated to another candidate delivery person B, a second delivery indicator corresponding to the order X in this case is estimated, and the first delivery indicator is compared with the second delivery indicator.

That the unallocated order is pre-assigned or pre-allocated to the target order group may be understood as that it is assumed that the unallocated order is assigned or allocated to the target order group.

To estimate the second delivery indicator, the unallocated order needs to be pre-allocated to the another candidate delivery person. In other words, in the foregoing example, the order X needs to be pre-allocated to the another candidate delivery person B.

Optionally, the unallocated order may be pre-allocated to the another candidate delivery person in a form of an order group. Specifically, a first order group corresponding to the unallocated order (the order X) may be obtained first. The first order group may be obtained by grouping a plurality of unallocated orders, and each of the plurality of unallocated orders may correspond to an allocated order group that meets the matching degree requirement. In this case, the second delivery indicator corresponds to that the first order group may be pre-allocated to the another candidate delivery person. In other words, the second delivery indicator corresponding to the unallocated order (the order X) when the first order group is pre-allocated to the another approximate candidate delivery person (the candidate delivery person B) is estimated.

The plurality of unallocated orders with each corresponding to the allocated order group that meets the matching degree requirement are a plurality of unallocated orders that are in the N unallocated orders received by the server and whose first matching degree with an allocated order group of a candidate delivery person meets the matching degree requirement. Each unallocated order corresponds to the first delivery business, and the allocated order group corresponds to the second delivery business.

In the example of the foregoing 50 unallocated orders, after the first matching degree for each of the 50 unallocated orders is calculated, if each of 30 orders corresponds to an allocated order group whose first matching degree with each of the 30 orders meets the matching degree requirement, the 30 orders are used as the plurality of unallocated orders, and grouped. Assuming that the 30 orders include the order X in the foregoing example, in this case, after the grouping, an order group that includes the order X is the first order group. Then, the appropriate candidate delivery person B is allocated to the first order group, and the second delivery indicator corresponding to the order X in a process of completing delivery of the first order group by the candidate delivery person B is estimated. The candidate delivery person B is selected based on a matching degree between the first order group and a candidate delivery person other than the candidate delivery person corresponding to the target order group. For a calculation process of the matching degree, the description in the grouping allocation process may be referred to.

For example, the unallocated order is the order X, and the candidate delivery person corresponding to the target order group is the candidate delivery person A. In this case, an estimation process of the first delivery indicator may be as follows. The order X is pre-assigned to the target order group, a delivery path is planned for the target order group to which the order X is assigned. Then the first delivery indicator corresponding to the order X in a process of delivering, by the candidate delivery person A, the target order group to which the order X is added is estimated based on information such as an order delivery sequence and a delivery distance between adjacent orders that are indicated in the delivery path, a preset driving speed of a delivery person, preset user waiting duration corresponding to each order, and a completion time and a completion location of a previous order group. The first delivery indicator may be a delivery distance, delivery duration, a delivery completion time required for completing delivery of the order X. The previous order group is an order group that needs to be delivered by the candidate delivery person corresponding to the target order group before the target order group.

The target order group may include not only a takeout order, but also a collect-on-delivery order. Therefore, during path planning, a delivery sequence of orders in the target order group may be determined based on delivery priorities of different delivery businesses. Optionally, a delivery path may be planned based on a shortest overall delivery time principle, a shortest overall delivery distance principle, or the like.

Based on the example in which the order X is grouped into the first order group, and the first order group is pre-allocated to the candidate delivery person B, an estimation process of the second delivery indicator may be as follows. The first order group is pre-allocated to the candidate delivery person B, a delivery path is further planned for the first order group, and then the second delivery indicator corresponding to the order X in a process of delivering the first order group by the candidate delivery person B is estimated based on information such as an order delivery sequence and a delivery distance between adjacent orders that are indicated in the delivery path, a preset driving speed of a delivery person, preset user waiting duration corresponding to each order, and a completion time and a completion location of a previous order group. The second delivery indicator may be a delivery distance, delivery duration, a delivery completion time required for completing delivery of the order X.

In conclusion, in the process of determining whether it is suitable to assign the unallocated order to an allocated order group, the delivery effect achieved in the assigning allocation manner is compared with the delivery effect achieved in the grouping allocation manner for the unallocated order, so that the unallocated order can be allocated in a manner with a better delivery effect.

The following describes in detail order allocation apparatuses in one or more embodiments of this disclosure. A person skilled in the art may understand that all these order allocation apparatuses may be configured by using hardware components sold in the market and based on the steps described in this solution.

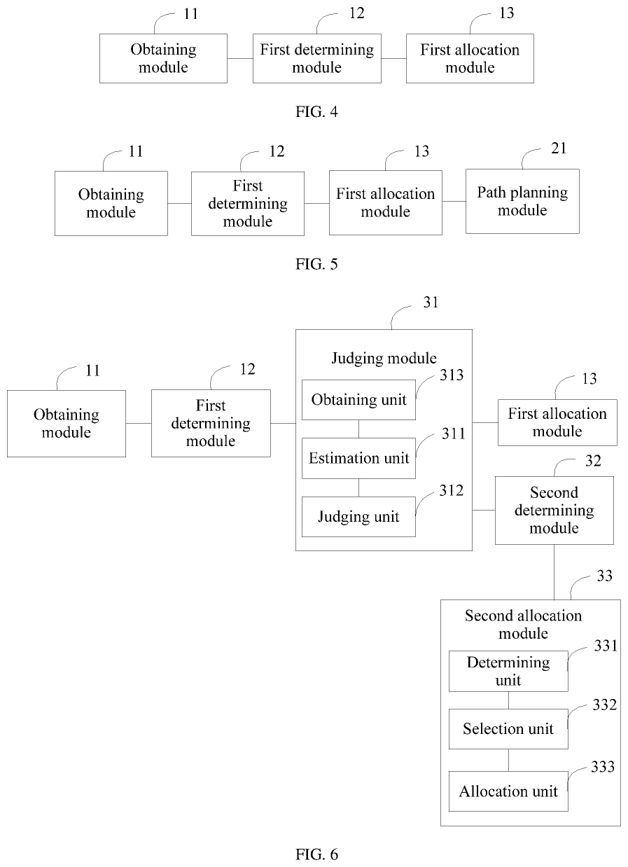

FIG. 4 is a schematic structural diagram of a first embodiment of an order allocation apparatus of this disclosure. As shown in FIG. 4, the apparatus may include an obtaining module 11, a first determining module 12, and a first allocation module 13.

The obtaining module 11 may be configured to obtain an unallocated order. The unallocated order may correspond to a first delivery business.

The first determining module 12 may be configured to determine a first matching degree between the unallocated order and each of allocated order groups of a plurality of candidate delivery persons. The allocated order groups may include an order group corresponding to a second delivery business.

The first allocation module 13 may be configured to: if there is an allocated order group that meets a matching degree requirement in the allocated order groups of the plurality of candidate delivery persons, designate the allocated order group that meets the matching degree requirement as a target order group, and assign the unallocated order to the target order group.

Optionally, the first allocation module 13 may be further configured to: if there are a plurality of allocated order groups that meet the matching degree requirement, select an optimal allocated order group from the plurality of allocated order groups as the target order group based on a correspondence between delivery capacity pressure and a delivery business and/or a comparison result of the first matching degree corresponding to each of the plurality of allocated order groups.

The apparatus shown in FIG. 4 may perform the method in the embodiment shown in FIG. 1. For a part that is not described in detail in this embodiment, and an execution process and a technical effect of this technical solution, related descriptions in the embodiment shown in FIG. 1 may be referred to. Details are not described herein again.

FIG. 5 is a schematic structural diagram of a second embodiment of an order allocation apparatus of this disclosure. As shown in FIG. 5, based on the embodiment shown in FIG. 4, the apparatus further includes a path planning module 21.

The path planning module 21 may be configured to: if the target order group corresponds to the second delivery business, plan, based on a delivery priority of the first delivery business and a delivery priority of the second delivery business, a new delivery path corresponding to the target order group.

The apparatus shown in FIG. 5 may perform the method in the embodiment shown in FIG. 2. For a part that is not described in detail in this embodiment, and an execution process and a technical effect of this technical solution, related descriptions in the embodiment shown in FIG. 2 may be referred to. Details are not described herein again.

FIG. 6 is a schematic structural diagram of a third embodiment of an order allocation apparatus of this disclosure. As shown in FIG. 6, based on the foregoing embodiments, the apparatus may further include a judging module 31.

The judging module 31 may be configured to determine whether it is suitable to assign the unallocated order to the target order group.

Optionally, the judging module 31 may include an estimation unit 311 and a judging unit 312.

The estimation unit 311 may be configured to estimate a first delivery indicator and a second delivery indicator that correspond to the unallocated order. The first delivery indicator may correspond to that the unallocated order being pre-assigned to the target order group, the second delivery indicator may correspond to that the unallocated order being pre-allocated to another candidate delivery person different from a candidate delivery person corresponding to the target order group.

The judging unit 312 may be configured to: if the first delivery indicator is superior to the second delivery indicator, determine that it is suitable to assign the unallocated order to the target order group.

Optionally, the judging module 31 may further include an obtaining unit 313.

The obtaining unit 313 may be configured to obtain a first order group corresponding to the unallocated order. The first order group may be obtained by grouping a plurality of unallocated orders, and each of the plurality of unallocated orders may correspond to an allocated order group that meets the matching degree requirement. In this case, the second delivery indicator may correspond to that the first order group being pre-allocated to the another candidate delivery person.

Optionally, the apparatus may further include a second determining module 32 and a second allocation module 33.

The second determining module 32 may be configured to: if the first delivery indicator is inferior to the second delivery indicator, determine, based on an order similarity, a second order group corresponding to the unallocated order. The second order group may be obtained by grouping a plurality of unallocated orders, and all of the plurality of unallocated orders are orders that are not suitable to be assigned.

The second allocation module 33 may be configured to allocate the second order group.

Optionally, the second allocation module 33 may include a determining unit 331, a selection unit 332, and an allocation unit 333.

The determining unit 331 may be configured to determine a second matching degree between the second order group and each of the plurality of candidate delivery persons.

The selection unit 332 may be configured to select, based on the second matching degree, a candidate delivery person that matches the second order group from the plurality of candidate delivery persons.

The allocation unit 333 may be configured to allocate the second order group to the selected candidate delivery person.

The apparatus shown in FIG. 6 may perform the method in the embodiment shown in FIG. 3. For a part that is not described in detail in this embodiment, and an execution process and a technical effect of this technical solution, related descriptions in the embodiment shown in FIG. 3 may be referred to. Details are not described herein again.

The described apparatus embodiment is merely an example. The units described as separate parts may or may not be physically separate, and parts displayed as units may or may not be physical units, and may be located in one position, or may be distributed on a plurality of network units. Some or all of the modules may be selected based on an actual requirement to achieve the objectives of the solutions of the embodiments. A person of ordinary skill in the art may understand and implement the embodiments without creative efforts.

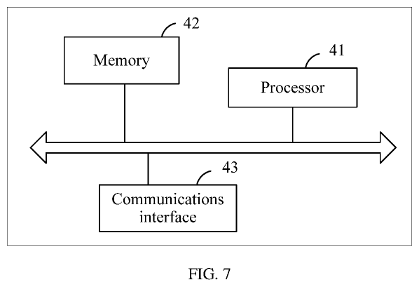

Internal functions and a structure of the order allocation apparatus are described above. In a possible design, the structure of the order allocation apparatus may be implemented as an electronic device. The electronic device may be, for example, a server. As shown in FIG. 7, the electronic device may include a processor 41 and a memory 42. The memory 42 may be configured to store a program that supports the order allocation apparatus in performing the order allocation method provided in any one of the foregoing embodiments. The processor 41 may be configured to execute the program stored in the memory 42.

The program may include one or more computer instructions executable by the processor 41. Upon being executed by the processor 41, the one or more computer instructions may perform the following steps: obtaining an unallocated order corresponding to a first delivery business; determining a first matching degree between the unallocated order and each of allocated order groups of a plurality of candidate delivery persons, wherein the allocated order groups include an order group corresponding to a second delivery business; and, if there is an allocated order group that meets a matching degree requirement in the allocated order groups of the plurality of candidate delivery persons, designating the allocated order group that meets the matching degree requirement as a target order group, and assigning the unallocated order to the target order group.

Optionally, the processor 41 may be further configured to perform all or some of the steps of the foregoing methods.

The structure of the order allocation apparatus may further include a communications interface 43, configured to be used by the order allocation apparatus to communicate with another device or a communications network.

In addition, this disclosure further provides a computer storage medium, configured to store a computer software instruction used by an order allocation apparatus, and the computer software instruction includes a related program used to perform the order allocation method in the foregoing method embodiments.

Based on the foregoing description of the implementations, a person skilled in the art may clearly understand that the implementations may be implemented by software in addition to a necessary universal hardware platform, or may be directly implemented by hardware. Based on such understanding, the foregoing technical solutions essentially or the part contributing to the related technologies may be implemented in a form of a computer product. This disclosure may use a form of a computer program product that is implemented on one or more computer-usable storage media (including but not limited to a disk memory, a CD-ROM, an optical memory, and the like) that include computer-usable program code.

This disclosure is described with reference to the flowcharts and/or block diagrams of the method, the device (system), and the computer program product according to the embodiments of this disclosure. It should be understood that computer program instructions may be used to implement each process and/or each block in the flowcharts and/or the block diagrams and a combination of a process and/or a block in the flowcharts and/or the block diagrams. These computer program instructions may be provided for a general purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer readable memory that can instruct a computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more processors (CPU), input/output interfaces, network interfaces, and memories.

The memory may include a non-persistent memory, a random access memory (RAM), a nonvolatile memory, and/or another form that are in a computer readable medium, for example, a read-only memory (ROM) or a flash memory (flash RAM). The memory is an example of the computer readable medium.

The computer readable medium includes persistent, non-persistent, movable, and unmovable media that may store information by using any method or technology. The information may be a computer readable instruction, a data structure, a program module, or other data. An example of a computer storage medium includes but is not limited to a parameter random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or other optical storage, a cassette magnetic tape, tape and disk storage or another magnetic storage device or any other non-transmission media that may be configured to store information that a computing device can access. As defined in this specification, the computer readable medium does not include transitory computer readable media (transitory media) (transitory media), such as a modulated data signal and a carrier.

Finally, it should be noted that the foregoing embodiments are merely intended for describing the technical solutions of this disclosure other than limiting this disclosure. Although this disclosure is described in detail with reference to the foregoing embodiments, a person of ordinary skill in the art should understand that the person may still make modifications to the technical solutions described in the foregoing embodiments or make equivalent replacements to some technical features thereof, without departing from the spirit and scope of the technical solutions of the embodiments of this disclosure.

What is claimed is:

1. An order allocation method, comprising:
obtaining an unallocated order, wherein the unallocated order corresponds to a first delivery business;
determining a first matching degree between the unallocated order and each of allocated order groups of a plurality of candidate delivery persons, wherein the allocated order groups comprise an order group corresponding to a second delivery business;
in response to one allocated order group of the allocated order groups of the plurality of candidate delivery persons meeting a matching degree requirement, designating the allocated order group that meets the matching degree requirement to be a target order group; and
assigning the unallocated order to the target order group.

2. The method of claim 1, further comprising: after assigning the unallocated order to the target order group,
in response to the target order group corresponding to the second delivery business, planning, based on a delivery priority of the first delivery business and a delivery priority of the second delivery business, a new delivery path corresponding to the target order group.

3. The method of claim 1, further comprising:
in response to a plurality of allocated order groups meeting the matching degree requirement, selecting, based on a correspondence between delivery capacity pressure and a delivery business and/or a comparison result of the first matching degree corresponding to each of the plurality of allocated order groups, an optimal allocated order group from the plurality of allocated order groups as the target order group.

4. The method of claim 1, further comprising: before assigning the unallocated order to the target order group,
determining whether it is suitable to assign the unallocated order to the target order group.

5. The method of claim 4, wherein determining whether it is suitable to assign the unallocated order to the target order group comprises:
estimating a first delivery indicator and a second delivery indicator that correspond to the unallocated order, wherein the first delivery indicator corresponds to that the unallocated order being pre-assigned to the target order group, the second delivery indicator corresponds to that the unallocated order being pre-assigned to another candidate delivery person different from a candidate delivery person corresponding to the target order group; and
in response to the first delivery indicator being superior to the second delivery indicator, determining that it is suitable to assign the unallocated order to the target order group.

6. The method claim 5, further comprising: before estimating a first delivery indicator and a second delivery indicator that correspond to the unallocated order,
obtaining a first order group corresponding to the unallocated order, wherein the first order group is obtained by grouping a plurality of unallocated orders, and each of the plurality of unallocated orders corresponds to an allocated order group that meets the matching degree requirement,
and wherein the second delivery indicator corresponds to the first order group being pre-assigned to the another candidate delivery person.

7. The method of claim 5, further comprising:
in response to the first delivery indicator being inferior to the second delivery indicator, determining, based on an order similarity, a second order group corresponding to the unallocated order, wherein the second order group is obtained by grouping a plurality of unallocated orders, and all of the plurality of unallocated orders are orders that are determined to be not suitable to be assigned to the target group; and
allocating the second order group.

8. The method of claim 7, wherein allocating the second order group comprises:
determining a second matching degree between the second order group and each of the plurality of candidate delivery persons;
selecting, based on the second matching degree, a candidate delivery person that matches the second order group from the plurality of candidate delivery persons; and
allocating the second order group to the selected candidate delivery person.

9. An order allocation apparatus, comprising:
an obtaining module, configured to obtain an unallocated order, wherein the unallocated order corresponds to a first delivery business;
a first determining module, configured to determine a first matching degree between the unallocated order and each of allocated order groups of a plurality of candidate delivery persons, wherein the allocated order groups comprise an order group corresponding to a second delivery business; and
a first allocation module, configured to:
in response to one allocated order group of the allocated order groups of the plurality of candidate delivery persons meeting a matching degree requirement, designate the allocated order group that meets the matching degree requirement as a target order group; and
assign the unallocated order to the target order group.

10. The apparatus of claim 9, further comprising:
a path planning module, configured to:
in response to the target order group corresponding to the second delivery business, plan, based on a delivery priority of the first delivery business and a delivery priority of the second delivery business, a new delivery path corresponding to the target order group.

11. The apparatus of claim 9, wherein the first allocation module is further configured to:
in response to a plurality of allocated order groups meeting the matching degree requirement, select, based on a correspondence between delivery capacity pressure and a delivery business and/or a comparison result of the first matching degree corresponding to each of the plurality of allocated order groups, an optimal allocated order group from the plurality of allocated order groups as the target order group.

12. The apparatus of claim 9, further comprising:
a judging module, configured to determine whether it is suitable to assign the unallocated order to the target order group.

13. The apparatus of claim 12, wherein the judging module comprises:
an estimation unit, configured to estimate a first delivery indicator and a second delivery indicator that correspond to the unallocated order, wherein the first delivery indicator corresponds to that the unallocated order being pre-assigned to the target order group, the second delivery indicator corresponds to that the unallocated order being pre-assigned to another candidate delivery person different from a candidate delivery person corresponding to the target order group; and
a judging unit, configured to:
in response to the first delivery indicator being superior to the second delivery indicator, determine that it is suitable to assign the unallocated order to the target order group.

14. The apparatus of claim 13, wherein the judging module comprises:
an obtaining unit, configured to obtain a first order group corresponding to the unallocated order, wherein the first order group is obtained by grouping a plurality of unallocated orders, and each of the plurality of unallocated orders corresponds to an allocated order group that meets the matching degree requirement,
and wherein the second delivery indicator corresponds to the first order group being pre-assigned to the another candidate delivery person.

15. The apparatus of claim 13, further comprising:
a second determining module, configured to:
in response to the first delivery indicator being inferior to the second delivery indicator, determine, based on an order similarity, a second order group corresponding to the unallocated order, wherein the second order group is obtained by grouping a plurality of unallocated orders, and all of the plurality of unallocated orders are orders that are determined to be not suitable to be assigned to the target group; and
a second allocation module, configured to allocate the second order group.

16. The apparatus of claim 15, wherein the second allocation module comprises:
a determining unit, configured to determine a second matching degree between the second order group and each of the plurality of candidate delivery persons;
a selection unit, configured to select, based on the second matching degree, a candidate delivery person that matches the second order group from the plurality of candidate delivery persons; and
an allocation unit, configured to allocate the second order group to the selected candidate delivery person.

17. An electronic device, comprising a memory and a processor, wherein
the memory is configured to store one or more computer instructions executable by the processor, and wherein upon being executed by the processor, the one or more computer instructions cause the processor to perform the order allocation method of claim 1.

18. A computer readable storage medium, storing a computer program executable by a computer, wherein upon being executed by the computer, the computer program causes the computer to perform the order allocation method of claim 1.
